(19) United States
(12) Patent Application Publication
(10) Pub. No.: US 2014/0089079 A1
(43) Pub. Date: Mar. 27, 2014

(54) METHOD AND SYSTEM FOR DETERMINING A CORRELATION BETWEEN AN ADVERTISEMENT AND A PERSON WHO INTERACTED WITH A MERCHANT

(71) Applicant: Texas Instruments Incorporated, Dallas, TX (US)

(72) Inventor: Goksel Dedeoglu, Plano, TX (US)

(73) Assignee: Texas Instruments Incorporated, Dallas, TX (US)

(21) Appl. No.: 14/032,426

(22) Filed: Sep. 20, 2013

Related U.S. Application Data
(60) Provisional application No. 61/704,784, filed on Sep. 24, 2012.

(51) Int. Cl. G06Q 30/02

(52) U.S. Cl. CPC G06Q 30/0242
USPC 705/14.41

(57) ABSTRACT

A query is generated for determining a correlation between an advertisement and a person who interacted with a merchant. The query includes an image of the person. In response to the query, a determination is made about whether the correlation exists between the image and a face that has given attention to the advertisement. In response to determining that the correlation exists, a report of the correlation is generated for the merchant.

### CROSS-REFERENCE TO RELATED APPLICATION

This application claims priority to U.S. Provisional Patent Application Ser. No. 61/704,784, filed Sep. 24, 2012, entitled METRICS AND METHODS FOR MEASURING THE INFLUENCE OF DIGITAL SIGNAGE ON A CUSTOMER'S SHOPPING AND PURCHASING DECISIONS, naming Goksel Dedeoglu as inventor, which is hereby fully incorporated herein by reference for all purposes.

### BACKGROUND

The disclosures herein relate in general to image processing, and in particular to a method and system for determining a correlation between an advertisement and a person who interacted with a merchant.

An advertisement may be displayed at a first location (e.g., digital signage location). A person may view the advertisement at the first location. Nevertheless, a challenge exists in determining a correlation between the advertisement at the first location and the person's interaction with a merchant at a second location.

### SUMMARY

A query is generated for determining a correlation between an advertisement and a person who interacted with a merchant. The query includes an image of the person. In response to the query, a determination is made about whether the correlation exists between the image and a face that has given attention to the advertisement. In response to determining that the correlation exists, a report of the correlation is generated for the merchant.

### BRIEF DESCRIPTION OF THE DRAWINGS

FIG. 1 is a data flow diagram of a system of the illustrative embodiments.

FIG. 2 is a block diagram of a representative computing device of the system of FIG. 1.

FIG. 3 is a block diagram of a camera operation for a representative agency of FIG. 1.

FIG. 4 is a block diagram of a first camera operation for a representative merchant of FIG. 1.

FIG. 5 is a block diagram of a second camera operation for the representative merchant of FIG. 1.

FIG. 6 is a block diagram of a third camera operation for the representative merchant of FIG. 1.

FIG. 7 is a flowchart of an operation of the representative agency of FIG. 1, in response to the camera operation of FIG. 3.

FIG. 8 is a flowchart of a first operation of the representative merchant of FIG. 1, in response to the first camera operation of FIG. 4.

FIG. 9 is a flowchart of a second operation of the representative merchant of FIG. 1, in response to the second camera operation of FIG. 5.

FIG. 10 is a flowchart of a third operation of the representative merchant of FIG. 1, in response to the third camera operation of FIG. 6.

FIG. 11 is a flowchart of an operation of a verifier of FIG. 1, in response to a query from the representative merchant of FIG. 1.

FIG. 12 is a flowchart of an operation of the representative agency of FIG. 1, in response to a query from the verifier of FIG. 1.

### DETAILED DESCRIPTION

FIG. 1 is a data flow diagram of a system, indicated generally at 100, of the illustrative embodiments. The system 100 includes a network 102, such as a Transport Control Protocol/Internet Protocol (“TCP/IP”) network (e.g., the Internet or an intranet). The network 102 is connected to advertising agencies 104 and 106, advertising agency cameras 108 and 110, merchants 112 and 114, and merchant cameras 116 and 118.

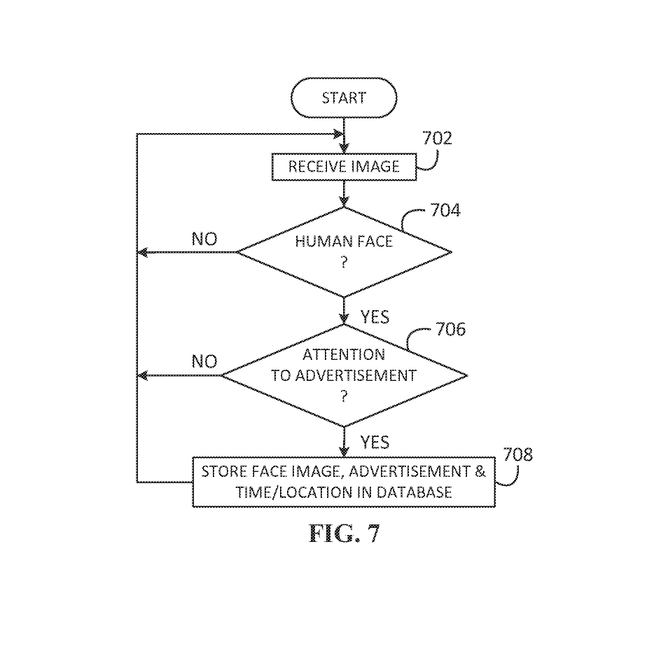

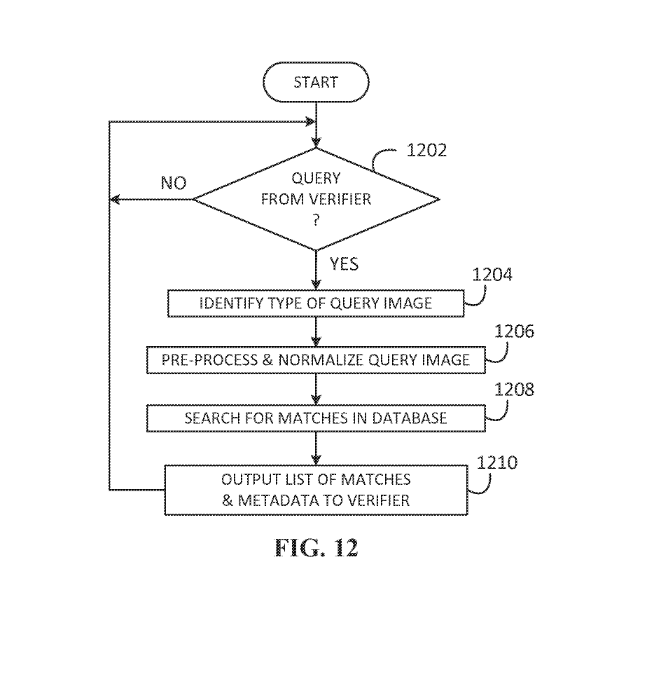

For clarity, although FIG. 1 shows two agencies 104 and 106, more such agencies are likewise connectable to the network 102. The agency 104 is a representative one of those agencies. Accordingly, the agency 104 performs advertising agency operations (discussed hereinbelow in connection with FIGS. 7 and 12), which are representative of similar operations performed by the agency 106 and the various other agencies (if any) connected to the network 102. Further, although FIG. 1 shows two advertising agency cameras 108 and 110, more such cameras are likewise connectable to the network 102.

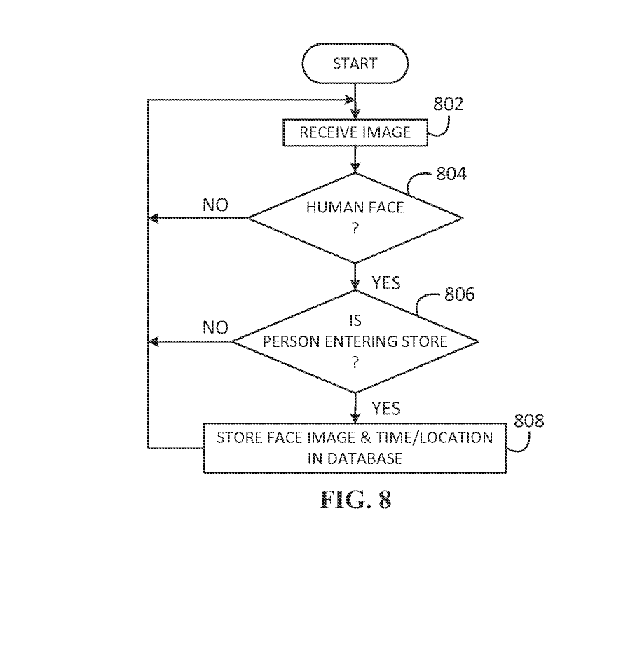

Likewise, although FIG. 1 shows two merchants 112 and 114, more such merchants are likewise connectable to the network 102. The merchant 112 is a representative one of those merchants. Accordingly, the merchant 112 performs merchant operations (discussed hereinbelow in connection with FIGS. 8, 9 and 10), which are representative of similar operations performed by the merchant 114 and the various other merchants (if any) connected to the network 102. Further, although FIG. 1 shows two merchant cameras 116 and 118, more such cameras are likewise connectable to the network 102.

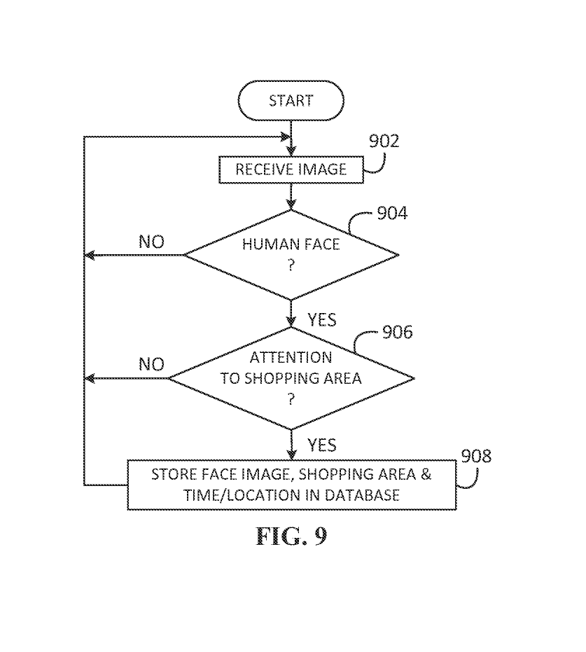

Moreover, the system 100 includes a verifier 120 for performing verification operations, discussed hereinbelow in connection with FIG. 9. The verifier 120 is coupled through the network 102 to: (a) the agency 104, the agency 106, and the various other agencies (if any) connected to the network 102; and (b) the merchant 112, the merchant 114, and the various other merchants (if any) connected to the network 102. Accordingly, through the network 102, information is electronically (e.g., wirelessly) communicated by the verifier 120: (a) to and from such agencies; and (b) to and from such merchants.

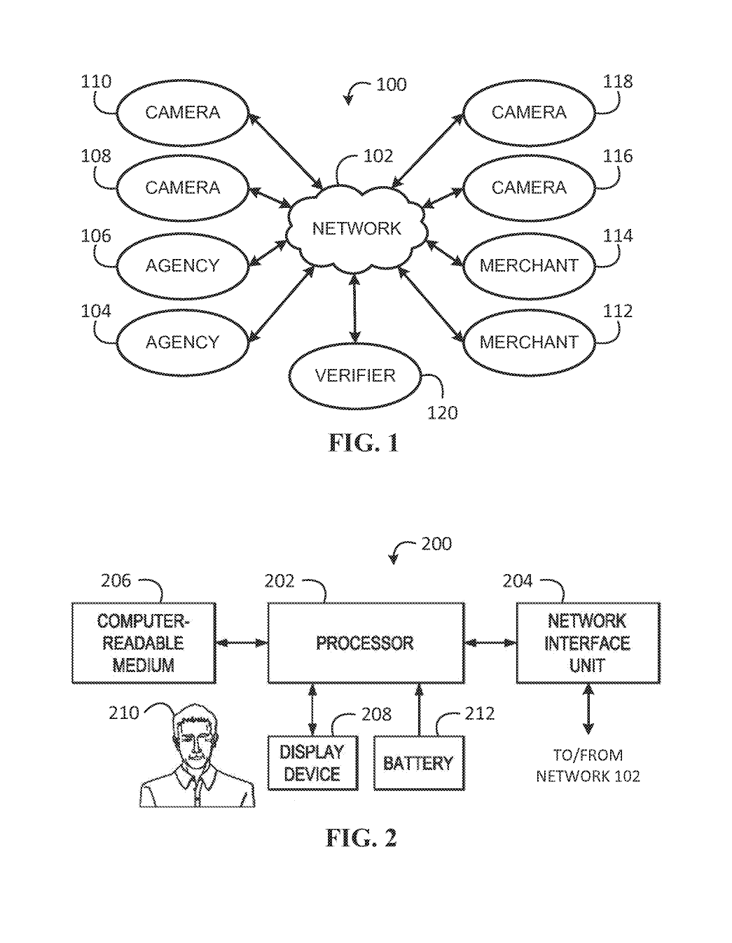

FIG. 2 is a block diagram of a representative computing device, indicated generally at 200, of the system 100. Each of the agencies 104 and 106, the merchants 112 and 114, and the verifier 120 includes a respective computing device, such as the representative computing device 200, for executing a respective process and automatically performing its respective operations (e.g., processing and communicating information) in response thereto. The computing device 200 includes various components (e.g., electronic circuitry components) for performing those operations, implemented in a suitable combination of hardware, firmware and software.

Such components include a processor 202 (e.g., one or more microprocessors and/or digital signal processors). The processor 202 is a general purpose computational resource for executing instructions of computer-readable software programs to: (a) process data (e.g., a database of information); and (b) perform additional operations (e.g., communicating information) in response thereto. Also, the system 100 includes a network interface unit 204 for: (a) communicating information to and from the network 102 in response to signals from the processor 202; and (b) after receiving information from the network 102, outputting such information to the processor 202, which performs additional operations in response thereto. Further, the system 100 includes a computer-readable medium 206, such as a nonvolatile storage device and/or a random access memory (“RAM”) device, for storing those programs, data and other information.

Moreover, the computing device 200 includes a display device 208. In this example, the display device 208 includes a touchscreen for displaying visual images (e.g., which represent information) in response to signals from the processor 202, so that a human user 210 is thereby enabled to view the visual images on the touchscreen. In one example, the computing device 200 operates in association with the user 210.

For example, in one embodiment, the touchscreen includes: (a) a liquid crystal display (“LCD”) device; and (b) touch-sensitive circuitry of such LCD device, so that the touch-sensitive circuitry is integral with such LCD device. Accordingly, the user 210 operates the touchscreen (e.g., virtual keys thereof, such as a virtual keyboard and/or virtual keypad) as an input device for specifying information (e.g., alphanumeric text information, such as commands) to the processor 202, which receives such information from the touchscreen. In this example, the touchscreen: (a) detects presence and location of a physical touch (e.g., by a finger of the user 210, and/or by a passive stylus object) within a display area of the touchscreen; and (b) in response thereto, outputs signals (indicative of such detected presence and location) to the processor 202. In that manner, the user 210 can: (a) touch (e.g., single tap and/or double tap) a portion of a visual image that is then-currently displayed by the touchscreen; and (b) thereby cause the touchscreen to output various information to the processor 202, which performs additional operations in response thereto.

A battery 212 is a source of power for the computing device 200. For clarity, although FIG. 2 shows the battery 212 connected to only the processor 202, the battery 212 is further coupled to various other components of the computing device 200. Moreover, the computing device 200 includes other electronic circuitry for performing additional operations of the computing device 200.

As shown in FIG. 2, the processor 202 is connected to the computer-readable medium 206, the display device 208, and the battery 212. Also, the processor 202 is coupled through the network interface unit 204 to the network 102. Accordingly, the network interface unit 204 communicates by outputting information to, and receiving information from, the processor 202 and the network 102, such as by transferring information (e.g. instructions, data, signals) between the processor 202 and the network 102 (e.g., wirelessly or through a USB interface).

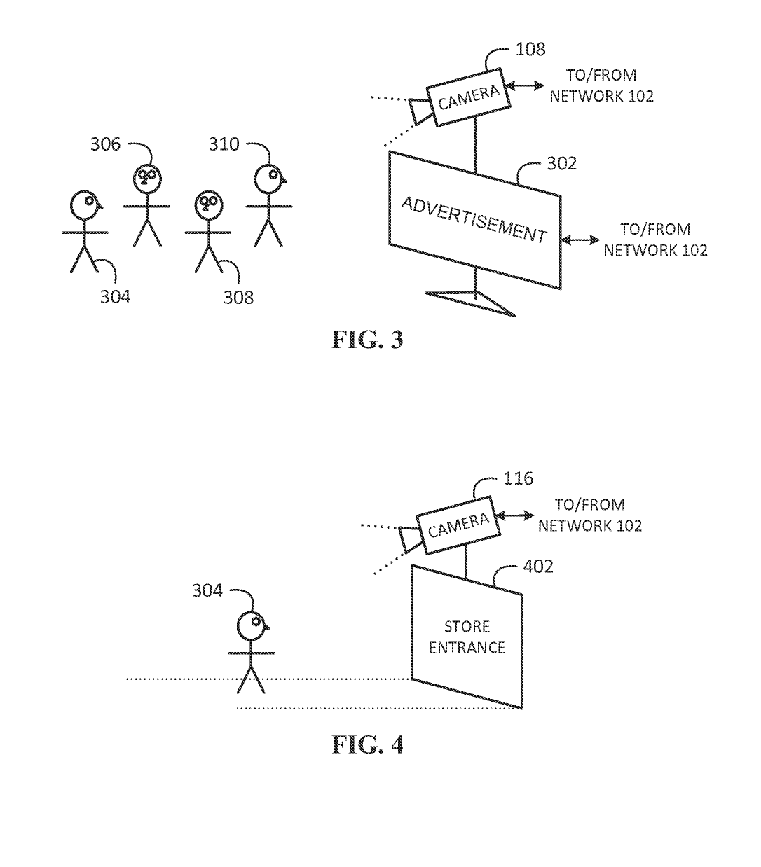

FIG. 3 is a block diagram of a camera operation for the representative agency 104. The camera 108: (a) views scenes (e.g., physical objects and their surrounding foregrounds and backgrounds); (b) captures and digitizes images of those views; and (c) through the network 102, electronically outputs those digitized (or “digital”) images to the agency 104. Such agency receives those captured digital images (e.g., a video sequence of captured digital images), writes those images for storage on such agency's respective computer-readable medium (FIG. 2), and automatically performs its respective advertising agency operations in response thereto.

An orientation and coordinates of the camera 108 are geometrically calibrated relative to an advertising display 302 (managed by the agency 104), which displays an advertisement for one or more items (e.g., products and/or services) from one or more merchants. In one embodiment, the agency 104 is able to modify the orientation and/or coordinates of the camera 108 by remote control through the network 102. Optionally, the advertising display 302 electronically receives the advertisement (e.g., as a digital image) from the agency 104 through the network 102, so the agency 104 is able to modify the advertisement by remote control through the network 102.

In the operation of FIG. 3, the camera 108 is suitably positioned at or near the advertising display 302, so that the camera 108 views scenes of various people 304, 306, 308 and 310 near the advertising display 302. In the example of FIG. 3, the people 304 and 310 are giving attention to (e.g., viewing) the advertisement (e.g., their gazes are directed toward the advertisement), while the people 306 and 308 are ignoring the advertisement.

Optionally, the camera 108 is connected (e.g., physically and/or electronically) to the advertising display 302. For example, in one embodiment, the camera 108 is integral with the advertising display 302. In one version of such embodiment, within a screen of the advertising display 302, the camera 108 occupies area that is approximately equal to a single pixel of the screen, so the camera 108 is almost invisible to the people 304, 306, 308 and 310. Accordingly, FIGS. 3-6 are not necessarily drawn to scale.

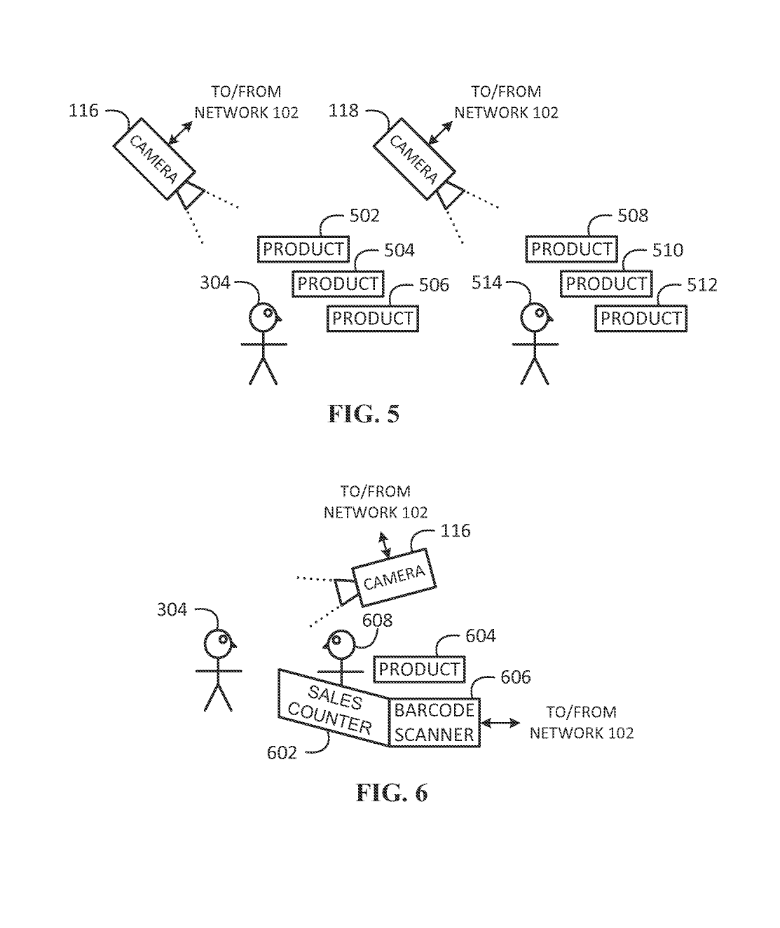

FIG. 4 is a block diagram of a first camera operation for the representative merchant 112. FIG. 5 is a block diagram of a second camera operation for the merchant 112. FIG. 6 is a block diagram of a third camera operation for the merchant 112.

An orientation and coordinates of the camera 116 are geometrically calibrated relative to a store, where the merchant 112 makes one or more items available for purchase. Similarly, an orientation and coordinates of the camera 118 are geometrically calibrated relative to the store. In one embodiment, the merchant 112 is able to modify the respective orientations and/or coordinates of the cameras 116 and/or 118 by remote control through the network 102.

In the operations of FIGS. 4, 5 and 6, the camera 116: (a) views scenes (e.g., physical objects and their surrounding foregrounds and backgrounds); (b) captures and digitizes images of those views; and (c) through the network 102, electronically outputs those digital images to the merchant 112. Similarly, the camera 118: (a) captures and digitizes images of its views; and (b) through the network 102, electronically outputs those digital images to the merchant 112. The merchant 112 receives those captured digital images (e.g., a video sequence of captured digital images) from the cameras 116 and 118, writes those images for storage on such merchant's respective computer-readable medium (FIG. 2), and automatically performs its respective merchant operations in response thereto.

In the operation of FIG. 4, the camera 116 is suitably positioned at or near a store entrance 402, so that the camera 116 views scenes of one or more people (e.g., the person 304) moving through the store entrance 402. Optionally, the camera 116 is connected (e.g., physically and/or electronically) to the store entrance 402. For example, in one embodiment, the camera 116 is electronically connected to the store entrance 402. In one version of such embodiment, the camera 116 captures and digitizes images in response to a person opening the store entrance 402 (e.g., in response to the person 304 causing an automatic door of the store entrance 402 to open).

In the operation of FIG. 5, the camera 116 is suitably positioned at or near a first shopping area (e.g., first aisle of a store) where one or more first products 502, 504 and 506 are displayed for purchase, so that the camera 116 views scenes of one or more people (e.g., the person 304) in the first shopping area. For example, while in the first shopping area, the person 304 may: (a) give attention to the first shopping area (e.g., by staying in the first shopping area for more than a threshold duration of time, and/or by directing his or her face's gaze toward at least one of the first products in such area); or (b) ignore the first shopping area.

Likewise, the camera 118 is suitably positioned at or near a second shopping area (e.g., second aisle of the store) where one or more second products 508, 510 and 512 are displayed for purchase, so that the camera 118 views scenes of one or more people (e.g., a person 514) in the second shopping area. For example, while in the second shopping area, the person 514 may: (a) give attention to the second shopping area (e.g., by staying in the second shopping area for more than a threshold duration of time, and/or by directing his or her face's gaze toward at least one of the second products in such area); or (b) ignore the second shopping area.

In the operation of FIG. 6, the camera 116 is suitably positioned at or near a sales counter 602 of the store, so that the camera 116 views scenes of one or more people (e.g., the person 304) purchasing one or more products (e.g., a product 604) and/or services (e.g., purchasing a car rental). In one example, the product 604 and/or service is identified by a barcode scanner 606. Optionally, the purchase transaction is assisted by a salesperson 608. In one embodiment: (a) through the network 102, the barcode scanner 606 outputs a report of the purchase transaction to the merchant 112; and (b) in response thereto, the merchant 112 associates such report with one or more images (contemporaneous with the purchase transaction) that the merchant 112 receives from the camera 116 and/or any other merchant camera(s) that is/are suitably positioned at or near the sales counter 602 where the purchase transaction has occurred.

FIG. 7 is a flowchart of an operation of the representative agency 104. Such operation is automatically performed by the respective computing device (FIG. 2) of the agency 104 in response to the camera operation of FIG. 3. At a step 702, the agency 104 receives an image from one of its advertising agency cameras (e.g., 108 or 110).

At a next step 704, the agency 104 analyzes the received image to determine whether at least one human face is identifiable within the received image. In response to the agency 104 determining that no human face is identifiable within the received image, the operation returns from the step 704 to the step 702 for a next received image. Conversely, in response to the agency 104 determining that at least one human face is identifiable within the received image, the operation continues from the step 704 to a step 706.

At the step 706, for each human face identifiable within the received image, the agency 104 analyzes the received image to determine whether such human face has given attention to (e.g., viewing) the advertisement (e.g., whether such human face's gaze is directed toward the advertisement). In response to the agency 104 determining that no human face (identifiable within the received image) has given attention to the advertisement, the operation returns from the step 706 to the step 702 for a next received image. Conversely, in response to the agency 104 determining that at least one human face (identifiable within the received image) has given attention to the advertisement, the operation continues from the step 706 to a step 708.

At the step 708, for each human face (identifiable within the received image) that has given attention to the advertisement, the agency 104 stores in a database (e.g., on such agency's respective computer-readable medium of FIG. 2): (a) a copy of such human face from the received image; (b) a description (e.g., location and/or content) of the advertisement (e.g., as displayed by the advertising display 302 of FIG. 3), and/or portion thereof (e.g., pricing component thereof), to which such human face has given attention; and (c) a time (including date) of such attention. After the step 708, the operation returns to the step 702 for a next received image.

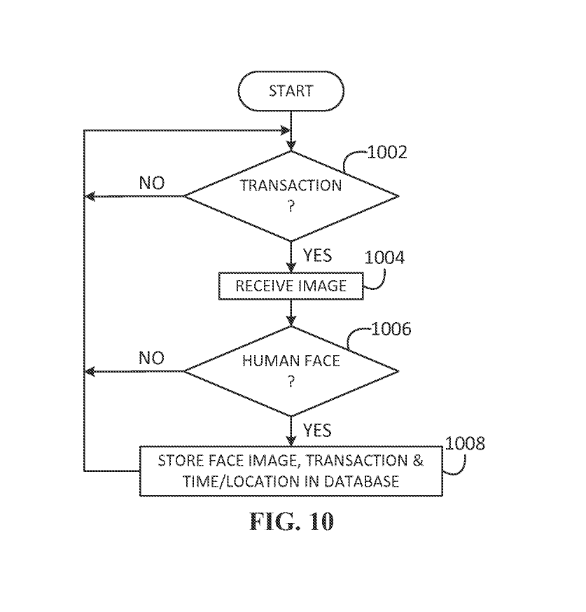

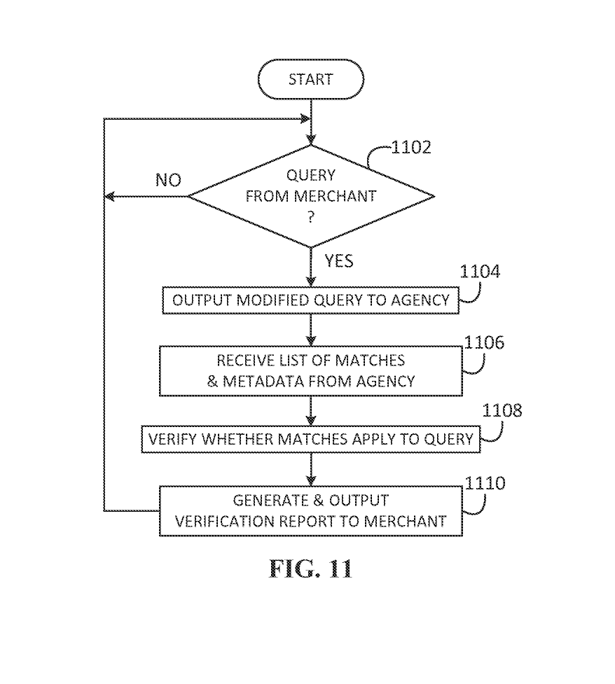

FIG. 8 is a flowchart of a first operation of the representative merchant 112. FIG. 9 is a flowchart of a second operation of the merchant 112. FIG. 10 is a flowchart of a third operation of the merchant 112. Such operations are automatically performed by the respective computing device (FIG. 2) of the merchant 112 in response to the first, second and third camera operations of FIGS. 4, 5 and 6 respectively.

Referring to FIG. 8, at a step 802, the merchant 112 receives an image from one of its merchant cameras (e.g., 116). At a next step 804, the merchant 112 analyzes the received image to determine whether at least one human face is identifiable within the received image. In response to the merchant 112 determining that no human face is identifiable within the received image, the operation returns from the step 804 to the step 802 for a next received image. Conversely, in response to the merchant 112 determining that at least one human face is identifiable within the received image, the operation continues from the step 804 to a step 806.

At the step 806, for each person (e.g., the person 304) whose face is identifiable within the received image, the merchant 112 analyzes the received image to determine whether such person is entering the store (e.g., through the store entrance 402 of FIG. 4). In response to the merchant 112 determining that no person (whose face is identifiable within the received image) is entering the store, the operation returns from the step 806 to the step 802 for a next received image. Conversely, in response to the merchant 112 determining that at least one person (whose face is identifiable within the received image) is entering the store, the operation continues from the step 806 to a step 808.

At the step 808, for each person (whose face is identifiable within the received image) that is entering the store, the merchant 112 stores in a database (e.g., on such merchant's respective computer-readable medium of FIG. 2): (a) a copy of such human face from the received image; (b) a location (e.g., physical address) of the store; and (c) a time (including date) of such entering. After the step 808, the operation returns to the step 802 for a next received image.

Referring to FIG. 9, at a step 902, the merchant 112 receives an image from one of its merchant cameras (e.g., 116 or 118). At a next step 904, the merchant 112 analyzes the received image to determine whether at least one human face is identifiable within the received image. In response to the merchant 112 determining that no human face is identifiable within the received image, the operation returns from the step 904 to the step 902 for a next received image. Conversely, in response to the merchant 112 determining that at least one human face is identifiable within the received image, the operation continues from the step 904 to a step 906.

At the step 906, for each person (e.g., the person 514) whose face is identifiable within the received image, the merchant 112 analyzes the received image to determine whether such person has given attention to a particular shopping area (e.g., whether such person has stayed in the particular shopping area for more than a threshold duration of time, and/or whether such face's gaze is directed toward at least one product in such area). In response to the merchant 112 determining that no person (whose face is identifiable within the received image) has given attention to a particular shopping area, the operation returns from the step 906 to the step 902 for a next received image. Conversely, in response to the merchant 112 determining that at least one person (whose face is identifiable within the received image) has given attention to a particular shopping area, the operation continues from the step 906 to a step 908.

At the step 908, for each person (whose face is identifiable within the received image) that has given attention to a particular shopping area, the merchant 112 stores in a database (e.g., on such merchant's respective computer-readable medium of FIG. 2): (a) a copy of such human face from the received image; (b) a location (e.g., aisle number) and description (e.g., product category) of the particular shopping area; and (c) a time (including date) of such attention. After the step 908, the operation returns to the step 902 for a next received image.

Referring to FIG. 10, the operation self-loops at a step 1002 until the merchant 112 receives a report of a purchase transaction (e.g., as reported by the barcode scanner 606 of FIG. 6 through the network 102). In response to the report of a purchase transaction, the operation continues from the step 1002 to a step 1004. At the step 1004, the merchant 112 receives one or more images (contemporaneous with the purchase transaction) from one or more of its merchant cameras (e.g., 116) that is/are suitably positioned at or near a sales counter (e.g., the sales counter 602 of FIG. 6) where the purchase transaction has occurred.

At a next step 1006, the merchant 112 analyzes the received image(s) to determine whether at least one human face is identifiable within the received image(s). In response to the merchant 112 determining that no human face is identifiable within the received image(s), the operation returns from the step 1006 to the step 1002 for a next purchase transaction. Conversely, in response to the merchant 112 determining that at least one human face is identifiable within the received image(s), the operation continues from the step 1006 to a step 1008.

At the step 1008, for each person (e.g., the person 304) whose face is identifiable within the received image(s), the merchant 112 stores in a database (e.g., on such merchant's respective computer-readable medium of FIG. 2): (a) a copy of such human face from the received image(s); (b) a location of the sales counter where the purchase transaction has occurred; and (c) a time (including date) of the purchase transaction. After the step 1008, the operation returns to the step 1002 for a next purchase transaction.

FIG. 11 is a flowchart of an operation of the verifier 120. Such operation is automatically performed by the respective computing device (FIG. 2) of the verifier 120. The operation self-loops at a step 1102 until the verifier 120 receives a query (or “inquiry”) from a merchant (e.g., the merchant 112) through the network 102.

Such query identifies a particular person (e.g., consumer) by including an image of the particular person's face (“query image”). Such query asks for a report of particular advertisements by particular advertising agencies that were effective in motivating the particular person to interact with such merchant, such as interaction in general and/or for a particular product and/or service (if specified by such query). Accordingly, such query specifies at least one of: such merchant; an advertising agency managing display of the advertisement; and a description of the advertisement (e.g., a location of the advertisement, a time period of the advertisement, and/or content of the advertisement, such as an item advertised therein). The particular person may have interacted with such merchant by: (a) entering a particular store of such merchant, as discussed hereinabove in connection with FIGS. 4 and 8; (b) giving attention to a particular shopping area of the particular store, as discussed hereinabove in connection with FIGS. 5 and 9; and/or (c) purchasing a particular item from the particular store, as discussed hereinabove in connection with FIGS. 6 and 10.

In response to such query, the operation continues from the step 1102 to a step 1104. At the step 1104, the verifier 120: (a) generates a modified version of such query (“modified query”), such as by removing information that identifies such merchant (e.g., so that such merchant is optionally anonymous in the modified query); and (b) outputs the modified query (including the query image) to the advertising agencies (e.g., 104 and 106) through the network 102. In response to the modified query, each of those advertising agencies searches its respective database to determine whether a sufficient correlation (or “match”) exists between: (a) the query image; and (b) one or more copies of human faces that such advertising agency stored in its respective database at the step 708 (FIG. 7).

At a next step 1106, through the network 102, the verifier 120 receives lists of those matches and their related information from each of those advertising agencies. For example, such related information includes: (a) copies of human faces for which the sufficient correlation exists (“associated faces”), as determined by such advertising agency; and (b) metadata of the descriptions and times that such advertising agency contemporaneously stored (together with those associated faces) in its respective database, as discussed hereinabove in connection with the step 708 (FIG. 7).

At a next step 1108, the verifier 120 independently verifies whether those matches are applicable to such query, so the verifier 120 rejects inapplicable matches (if any). Accordingly, for each match that the verifier 120 receives (at the step 1106) from an advertising agency, the verifier 120 (at the step 1108): (a) independently determines whether a sufficient correlation exists between the query image and such match's associated face; (b) accepts such match (“verified match”) in response to the sufficient correlation being confirmed by such independent determination, but only if such match's related information is applicable (e.g., relevant) to such merchant's query about particular advertisements by particular advertising agencies that were effective in motivating the particular person to interact with such merchant; and (c) conversely, rejects such match (“rejected match”) in response to the sufficient correlation being unconfirmed by such independent determination, or in response to such match's related information being inapplicable (e.g., irrelevant) to such merchant's query.

At a next step 1110, the verifier 120 generates a report of the verified matches (“verification report”) and outputs the verification report to such merchant through the network 102. The verification report answers such merchant's query about particular advertisements by particular advertising agencies that were effective in motivating the particular person to interact with such merchant. Accordingly, the verification report includes the verified matches' related information (e.g., the associated faces, and their contemporaneously stored metadata, from the advertising agencies), which is supporting evidence of the verified matches. In that manner, the verification reports provide objective information for the merchants 112 and 114 to use in analyzing (e.g., statistically) efficacy of their advertisements (e.g., at digital signage locations, such as the advertising display 302). After the step 1110, the operation returns to the step 1102 for a next query from a merchant.

FIG. 12 is a flowchart of an operation of the representative agency 104. Such operation is automatically performed by the respective computing device (FIG. 2) of the agency 104. The operation self-loops at a step 1202 until the agency 104 receives the modified query from the verifier 120 through the network 102, as discussed hereinabove in connection with the step 1104 (FIG. 11).

In response to the modified query, the operation continues from the step 1202 to a step 1204. At the step 1204, the agency 104 identifies a type of the query image (e.g., face only, or full body). At a next step 1206, the agency 104 pre-processes and normalizes the query image.

At a next step 1208, the agency 104 searches its respective database to determine whether a sufficient correlation (or “match”) exists between: (a) the query image; and (b) one or more copies of human faces that the agency 104 stored in its respective database at the step 708 (FIG. 7), but only if such face's related information is applicable (e.g., relevant) to the modified query about particular advertisements that were effective in motivating the particular person to interact with such merchant, as discussed hereinabove in connection with the step 1108 (FIG. 11). At a next step 1210, through the network 102, the agency 104 outputs its list of those matches and their related information to the verifier 120, as discussed hereinabove in connection with the step 1106 (FIG. 11). After the step 1210, the operation returns to the step 1202 for a next modified query from the verifier 120.

Accordingly, the system 100: (a) collects evidence of consumer behavior on a person-by-person basis (e.g., micro-level), which is more precise than macro-level analysis of advertisement efficacy (e.g., average sales data for a particular street or shopping mall); (b) is cost efficient, because it can leverage existing camera infrastructure at stores (e.g., retail spaces), and at digital signage locations (e.g., the advertising display 302); (c) is relatively unobtrusive, because consumers may continue to freely engage in their customary shopping behavior; (d) helps to preserve privacy, because actual names of consumers may remain anonymous, and because the merchants can remain anonymous, in the modified queries from the verifier 120 to the advertising agencies; and (e) supports truthful business practices, because the verifier 120 independently verifies whether a sufficient correlation exists before reporting a match to a merchant, together with supporting evidence of the verified matches.

In a first alternative embodiment, the merchants 112 and 114 output (through the network 102) their respective databases to the verifier 120, so that the verifier 120 (instead of the merchants 112 and 114) automatically generates the queries in response to the database's images of people who have interacted with such merchants. In a second alternative embodiment, the agencies 104 and 106 output (through the network 102) their respective databases to the verifier 120, so that the verifier 120 (instead of the agencies 104 and 106) automatically searches those databases (to identify the matches and their related information) in response to the queries.

In the illustrative embodiments, a computer program product is an article of manufacture that has: (a) a computer-readable medium; and (b) a computer-readable program that is stored on such medium. Such program is processable by an instruction execution apparatus (e.g., system or device) for causing the apparatus to perform various operations discussed hereinabove (e.g., discussed in connection with a block diagram). For example, in response to processing (e.g., executing) such program's instructions, the apparatus (e.g., programmable information handling system) performs various operations discussed hereinabove. Accordingly, such operations are computer-implemented.

Such program (e.g., software, firmware, and/or microcode) is written in one or more programming languages, such as: an object-oriented programming language (e.g., C++); a procedural programming language (e.g., C); and/or any suitable combination thereof. In a first example, the computer-readable medium is a computer-readable storage medium. In a second example, the computer-readable medium is a computer-readable signal medium.

A computer-readable storage medium includes any system, device and/or other non-transitory tangible apparatus (e.g., electronic, magnetic, optical, electromagnetic, infrared, semiconductor, and/or any suitable combination thereof) that is suitable for storing a program, so that such program is processable by an instruction execution apparatus for causing the apparatus to perform various operations discussed hereinabove. Examples of a computer-readable storage medium include, but are not limited to: an electrical connection having one or more wires; a portable computer diskette; a hard disk; a random access memory (“RAM”); a read-only memory (“ROM”); an erasable programmable read-only memory (“EPROM” or flash memory); an optical fiber; a portable compact disc read-only memory (“CD-ROM”); an optical storage device; a magnetic storage device; and/or any suitable combination thereof.

A computer-readable signal medium includes any computer-readable medium (other than a computer-readable storage medium) that is suitable for communicating (e.g., propagating or transmitting) a program, so that such program is processable by an instruction execution apparatus for causing the apparatus to perform various operations discussed hereinabove. In one example, a computer-readable signal medium includes a data signal having computer-readable program code embodied therein (e.g., in baseband or as part of a carrier wave), which is communicated (e.g., electronically, electromagnetically, and/or optically) via wireline, wireless, optical fiber cable, and/or any suitable combination thereof.

Although illustrative embodiments have been shown and described by way of example, a wide range of alternative embodiments is possible within the scope of the foregoing disclosure.

What is claimed is:

1. A method performed by at least one computing device for determining a correlation between an advertisement and a person who interacted with a merchant, the method comprising:
generating a query that includes an image of the person;
in response to the query, determining whether the correlation exists between the image and a face that has given attention to the advertisement; and
in response to determining that the correlation exists, generating a report of the correlation for the merchant.

2. The method of claim 1, wherein the face has given the attention by viewing the advertisement.

3. The method of claim 1, wherein generating the query includes:
generating the query in response to the person interacting with the merchant by at least one of: entering a store of the merchant; giving attention to a shopping area of the store; and purchasing an item from the store.

4. The method of claim 1, and comprising:
from the merchant, receiving an inquiry that includes the image;
wherein the inquiry specifies at least one of: the merchant; an agency managing display of the advertisement; and a description of the advertisement; and
wherein generating the query includes generating the query in response to the inquiry.

5. The method of claim 4, wherein the merchant is anonymous in the query.

6. The method of claim 4, wherein generating the report includes:
in response to determining that the correlation exists, generating the report of the correlation for the merchant, but only if the correlation is applicable to the inquiry.

7. The method of claim 1, and comprising:
outputting the query to an agency managing display of the advertisement; and
from the agency, in response to the query, receiving the face and information about the attention;
wherein the information includes at least one of: a time of the attention; and a description of the advertisement.

8. The method of claim 7, wherein the report includes the information.

9. The method of claim 1, wherein the face is captured by a camera at a location of the advertisement in response to the attention.

10. The method of claim 1, wherein the image is captured by a camera at a store of the merchant in response to the person interacting with the merchant.

11. A system for determining a correlation between an advertisement and a person who interacted with a merchant, the system comprising:
at least one computing device for: generating a query that includes an image of the person; in response to the query, determining whether the correlation exists between the image and a face that has given attention to the advertisement; and, in response to determining that the correlation exists, generating a report of the correlation for the merchant.

12. The system of claim 11, wherein the face has given the attention by viewing the advertisement.

13. The system of claim 11, wherein generating the query includes:
generating the query in response to the person interacting with the merchant by at least one of: entering a store of the merchant; giving attention to a shopping area of the store; and purchasing an item from the store.

14. The system of claim 11, wherein the at least one computing device is for: from the merchant, receiving an inquiry that includes the image;
wherein the inquiry specifies at least one of: the merchant; an agency managing display of the advertisement; and a description of the advertisement; and
wherein generating the query includes generating the query in response to the inquiry.

15. The system of claim 14, wherein the merchant is anonymous in the query.

16. The system of claim 14, wherein generating the report includes:
in response to determining that the correlation exists, generating the report of the correlation for the merchant, but only if the correlation is applicable to the inquiry.

17. The system of claim 11, wherein the at least one computing device is for: outputting the query to an agency managing display of the advertisement; and, from the agency, in response to the query, receiving the face and information about the attention;
wherein the information includes at least one of: a time of the attention; and a description of the advertisement.

18. The system of claim 17, wherein the report includes the information.

19. The system of claim 11, wherein the face is captured by a camera at a location of the advertisement in response to the attention.

20. The system of claim 11, wherein the image is captured by a camera at a store of the merchant in response to the person interacting with the merchant.

21. A method performed by at least one computing device for determining a correlation between an advertisement and a person who interacted with a merchant, the method comprising:
from the merchant, receiving an inquiry that includes an image of the person;
in response to the inquiry, generating a query that includes the image, and outputting the query to an agency managing display of the advertisement;
from the agency, in response to the query, receiving a face that viewed the advertisement, and receiving information about the viewing;
determining whether the correlation exists between the image and the face; and
in response to determining that the correlation exists, generating a report of the correlation for the merchant, but only if the correlation is applicable to the inquiry, wherein the report includes the information;
wherein the inquiry specifies at least one of: the merchant; the agency; and a description of the advertisement;
wherein the image is captured by a first camera at a store of the merchant in response to the person interacting with the merchant by at least one of: entering the store; giving attention to a shopping area of the store; and purchasing an item from the store;
wherein the face is captured by a second camera at a location of the advertisement in response to the viewing; and
wherein the information includes at least one of: a time of the viewing; and the description of the advertisement.

22. The method of claim 21, wherein the merchant is anonymous in the query.

23. A system for determining a correlation between an advertisement and a person who interacted with a merchant, the system comprising:
at least one computing device for: from the merchant, receiving an inquiry that includes an image of the person; in response to the inquiry, generating a query that includes the image, and outputting the query to an agency managing display of the advertisement; from the agency, in response to the query, receiving a face that viewed the advertisement, and receiving information about the viewing; determining whether the correlation exists between the image and the face; and, in response to determining that the correlation exists, generating a report of the correlation for the merchant, but only if the correlation is applicable to the inquiry, wherein the report includes the information;
wherein the inquiry specifies at least one of: the merchant; the agency; and a description of the advertisement;
wherein the image is captured by a first camera at a store of the merchant in response to the person interacting with the merchant by at least one of: entering the store; giving attention to a shopping area of the store; and purchasing an item from the store;
wherein the face is captured by a second camera at a location of the advertisement in response to the viewing; and
wherein the information includes at least one of: a time of the viewing; and the description of the advertisement.

24. The system of claim 23, wherein the merchant is anonymous in the query.
